(19) United States
(12) Patent Application Publication
(10) Pub. No.: US 2011/0261272 A1
(43) Pub. Date: Oct. 27, 2011

(54) VIDEO PROJECTOR

(75) Inventor: Kazunori Kotani, Nara-shi (JP)

(73) Assignee: SANYO ELECTRIC CO., LTD., Osaka (JP)

(21) Appl. No.: 13/086,891

(22) Filed: Apr. 14, 2011

(30) Foreign Application Priority Data
Apr. 21, 2010 (JP) 2010-098046

(51) Int. Cl. H04N 5/64

(52) U.S. Cl. 348/789; 348/E05.128

(57) ABSTRACT

A video projector including replaceable light source lamps, a case that accommodates the light source lamps, lamp covers respectively corresponding to the light source lamps, a time measurement unit that measures an accumulated illumination time of each of the light source lamps, a control unit that determines whether or not the measured accumulated illumination time is greater than a replacement determination time, and notification units respectively corresponding to the light sources. Each notification unit is illuminated, when it is determined that the accumulated illumination time of the corresponding light source lamp is greater than the replacement determination time, to indicate where the corresponding lamp cover is located.

### CROSS-REFERENCE TO RELATED APPLICATIONS

This application is based upon and claims the benefit of priority from prior Japanese Patent Application No. 2010-098046, filed on Apr. 21, 2010, the entire contents of which are incorporated herein by reference.

### BACKGROUND OF THE INVENTION

The present invention relates to a video projector, and more particularly, to a video projector including a notification unit that notifies a user of the necessity to replace a light source lamp.

A discharge type light source lamp, such as an ultra-high pressure mercury lamp or a metal halide lamp, is used as a light source lamp of a video projector. The luminance of a discharge type light source lamp gradually decreases as its usage time (illumination time) becomes longer. Continuous use of a discharge type light source lamp lowers the quality of images displayed by the video projector and illumination of the light source lamp may become difficult.

There are video projectors in the prior art that notify a user of the necessity to replace the light source lamp before such a problem occurs. For example, Japanese Laid-Open Patent Publication No. 2000-267061 describes a video projector that projects the image of a message prompting the user to replace the light source lamp.

Japanese Laid-Open Patent Publication No. 2007-218948 describes a video projector including a control unit that compares an accumulated illumination time of a light source lamp with a predetermined replacement determination time when a light source lamp is switched off. When the accumulated illumination time becomes greater than the replacement determination time, the control unit electromagnetically opens a lamp cover.

However, a user may not be accustomed to handling the video projector of the '061 publication. Even when a message such as that described above is displayed, the user would not know how to replace the light source lamp. The user may not even know the location of the light source lamp that needs to be replaced. As a result, the light source lamp may not be replaced. Continuous use of the light source lamp may hinder the display of an image with the appropriate luminance. In addition, the lamp may fail to function normally when an image is being viewed and thereby confuse the user.

The video projector of the '948 publication includes an additional automatic lamp cover opening device. This increases the cost of the video projector and enlarges a shell case of the video projector. In particular, when the video projector uses a plurality of light source lamps, the problem of the increase in cost and enlarged size becomes more significant. Further, since the automatic lamp cover opening device automatically opens the lamp cover, there may be interference between the lamp cover and an object near the video projector. This may damage the object or the lamp cover. Further, in the '948 publication, when a plurality of video projectors are overlapped with one another to perform blending, the automatic opening device may attempt to open a lamp cover, which is forcibly held in an unmovable state. This may result in abnormal operation of the automatic opening device. To avoid such a situation, sufficient space must be provided around the lamp cover. This limits the layout freedom of the video projector.

### SUMMARY OF THE INVENTION

One aspect of the present invention is a video projector including a replaceable light source lamp. A case accommodates the light source lamp. The case includes a service port arranged in correspondence with the light source lamp. A lamp cover is arranged on the case to close the service port. The lamp cover opens to allow for the light source lamp to be replaced through the service port. A time measurement unit measures an accumulated illumination time of the light source lamp. A control unit determines whether or not the accumulated illumination time of the light source lamp is greater than a replacement determination time. A notification unit includes a notification lamp and illuminates the notification lamp, when it is determined that the accumulated illumination time of the light source lamp is greater than the replacement determination time, to indicate where the lamp cover corresponding to the light source lamp is located.

Another aspect of the present invention is a video projector including a plurality of replaceable light source lamps. A case accommodates the light source lamps. The case includes a plurality of service ports used to replace the light source lamps, respectively. A plurality of lamp covers are arranged on the case to close the service ports. The lamp covers respectively correspond to the light source lamps. Each of the lamp covers opens to allow for the corresponding light source lamp to be replaced through the corresponding service port. A time measurement unit measures an accumulated illumination time of each of the light source lamps. A control unit determines whether or not the measured accumulated illumination time is greater than a replacement determination time. A plurality of notification units are arranged on the case. The notification units respectively correspond to the light source lamps. Each of the notification units is illuminated, when it is determined that the accumulated illumination time of the corresponding light source lamp is greater than the replacement determination time, to indicate where the corresponding lamp cover is located.

A further aspect of the present invention is a video projector including a plurality of light source lamps. A case accommodates the light source lamps. The case includes a plurality of lamp covers respectively corresponding to the light source lamps. Each of the lamp covers opens to allow for the corresponding light source lamp to be accessed. A time measurement unit measures an accumulated illumination time of each of the light source lamps. A control unit determines whether or not the measured accumulated illumination time is greater than a replacement determination time. A plurality of notification units are arranged on the case. The notification units respectively correspond to the light sources. Each of the notification units is illuminated, when it is determined that the accumulated illumination time of the corresponding light source lamp is greater than the replacement determination time, to indicate where the corresponding lamp cover is located.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a video projector according to one embodiment of the present invention;

FIG. 2 is a plan view showing the video projector of FIG. 1;

FIG. 3 is a schematic diagram showing an optical system in the video projector of FIG. 1;

FIG. 4 is a block diagram of the video projector of FIG. 1;

FIG. 5 is a flowchart for controlling notification lamps in the video projector of FIG. 1; and

FIG. 6 is a plan view showing a video projection according to a further embodiment of the present invention.

### DETAILED DESCRIPTION OF THE INVENTION

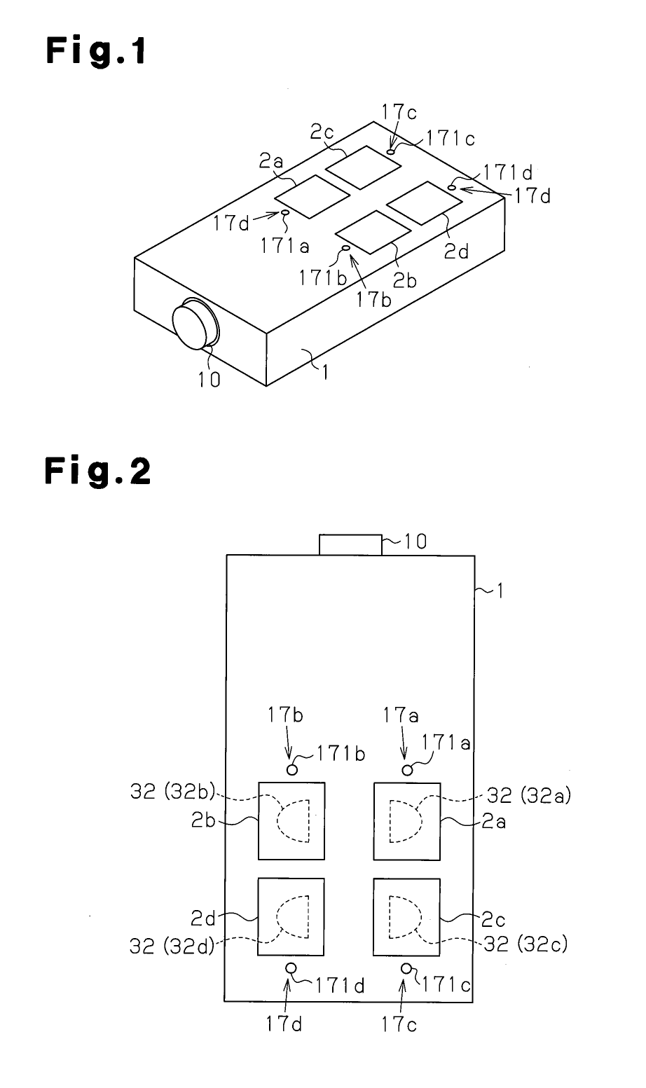

A video projector according to one embodiment of the present invention will now be described with reference to FIGS. 1 to 5.

FIG. 1 shows a state in which the video projector is held upright. As shown in FIGS. 1 and 2, the video projector includes a shell case 1 and a projection lens 10. Lamp covers 2a to 2d for light source lamps 32 are arranged on an upper surface of the shell case 1. Each of the lamp covers 2a to 2d serves as a lid that closes a service port used when replacing the corresponding light source lamp 32. As shown in FIG. 2, the four lamp covers 2a to 2d are respectively arranged in correspondence with four light source lamps 32a to 32d. For example, when replacing the light source lamp 32a, a user opens the lamp cover 2a corresponding to the light source lamp 32a to access the light source lamp 32a through the corresponding service port. In the description hereafter, the state of FIG. 1 will be used as a frame of reference when referring to a vertical direction unless otherwise mentioned. Further, the direction in which light travels will be referred to as a frontward direction.

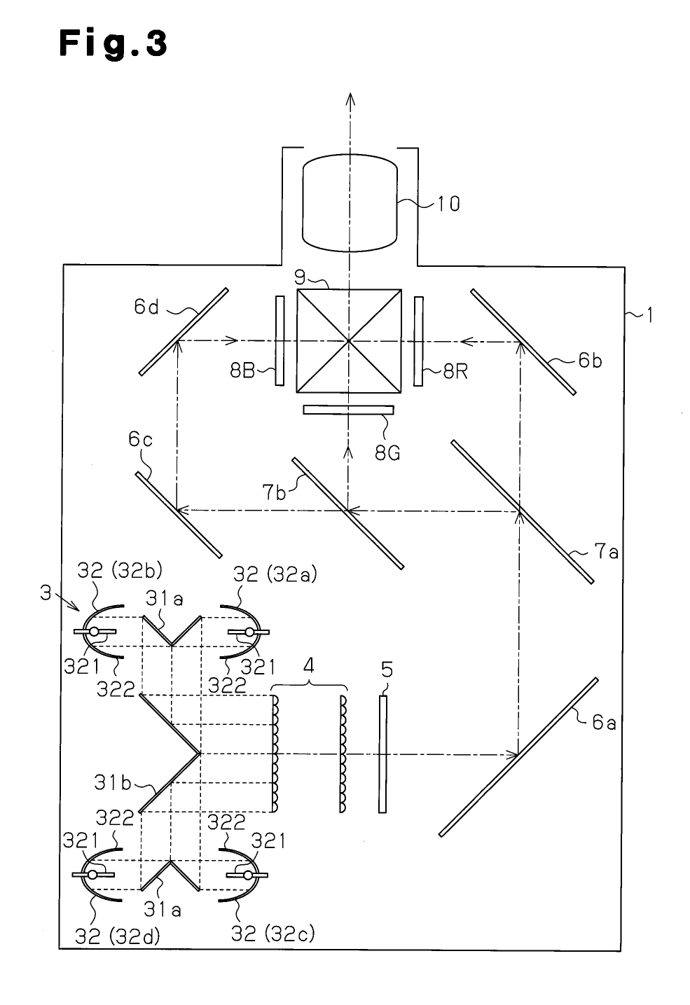

The video projector is, for example, a three-chip LCD projector. An optical system of the video projector will now be described with reference to FIG. 3. The optical system includes a light source device 3, an integrator lens 4, a polarization conversion element 5, reflection mirrors 6a, 6b, 6c, and 6d, dichroic mirrors 7a and 7b, liquid crystal light valves 8R, 8G, and 8B, a dichroic prism 9, and the projection lens 10.

The light source device 3 includes two first light path changing members 31a, a single second light path changing member 31b, and the first to fourth light source lamps 32a to 32d. The first and second light source lamps 32a and 32b are arranged on opposite sides of one of the first light path changing members 31a. The third and fourth light source lamps 32c and 32d are arranged on opposite sides of the other one of the first light path changing members 31a. The two first light path changing members 31a are optically coupled to the second light path changing member 31b. As a result, light flux from the four light source lamps 32a to 32d is emitted in the same direction from the second light path changing member 31b. In the description hereafter, the first to fourth light source lamps 32a to 32d are collectively referred to as the light source lamps 32 unless otherwise mentioned.

Each light source lamp 32 includes an arc tube 321 and a reflector 322, which is formed by a parabolic reflection surface. The arc tube 321 includes a spherical portion and a cylindrical portion. The arc tube 321 is formed from silica glass. A luminous material, which may be a mixture of mercury and halogen gas or a mixture of mercury and a halogen compound, is sealed in the spherical portion of the arc tube 321. Part of an electrode extending to the spherical portion is embedded in the cylindrical portion of the arc tube 321. The parabolic reflection surface of the reflector 322 is open toward the front. The spherical portion is arranged at the focal point of the parabolic surface of the reflector 322. The reflector 322 reflects the light emitted from the arc tube 321 and produces collimated light, which is emitted toward the front.

Each of the first and second light path changing members 31a and 31b may be L-shaped and include two flat reflection surfaces. The second light path changing member 31b is about two times larger than the first light path changing member 31a. One of the first light path changing members 31a reflects the generally collimated light emitted from the first and second light source lamps 32a and 32b toward one of the reflection surfaces of the second light path changing member 31b. The other one of the first light path changing members 31a reflects the generally collimated light emitted from the first and second light source lamps 32a and 32b toward the other one of the reflection surfaces of the second light path changing member 31b. The second light path changing member 31b reflects the light flux of the combination of the first and second light source lamps 32a and 32b and the light flux of the combination of the third and fourth light source lamps 32c and 32d toward an entrance surface of the integrator lens 4.

The integrator lens 4 is formed by, for example, two fly's eye lenses. Each fly's eye lens includes lens portions and each of the lens portions entirely irradiates the surfaces of the liquid crystal light valves 8R, 8G, and 8B with the light emitted from the light source lamps 32.

The polarization conversion element 5 is formed by a polarization separation film and a plurality of small polarization beam splitter arrays. The polarization conversion element 5 converts the light from the integrator lens 4 to one type of linear polarized light and emits the polarized light.

Each of the reflection mirrors 6a, 6b, 6c, and 6d reflects light in a predetermined direction. The dichroic mirrors 7a and 7b separate the light (white light) emitted from the light source lamps into the three primary colors of light, which are red, blue, and green. The dichroic mirror 7a transmits red light and reflects green and blue light. The dichroic mirror 7b transmits blue light and reflects green light.

The liquid crystal light valves 8R, 8G, and 8B modulate the light, which has been color-separated and emitted from the light source lamps 32, in accordance with image data. The liquid crystal light valve 8R, which is for red light, modulates red light components. The liquid crystal light valve 8G, which is for green light, modulates green light components. The liquid crystal light valve 8B, which is for blue light, modulates blue light components. Each of the liquid crystal light valves 8R, 8G, and 8B is formed by an entrance side polarization plate, a liquid crystal panel, an optical compensation plate, and an exit side polarization plate (none shown).

The dichroic prism 9 combines the three colors of image light emitted from the liquid crystal light valves 8R, 8G, and 8B to generate projectable image light. Then, the dichroic prism 9 sends the image light to the projection lens 10.

The projection lens 10 is formed by a group of lenses. The projection lens 10 enlarges the image light generated by the dichroic prism 9 and projects the enlarged image light onto a display surface such as a screen or a wall surface.

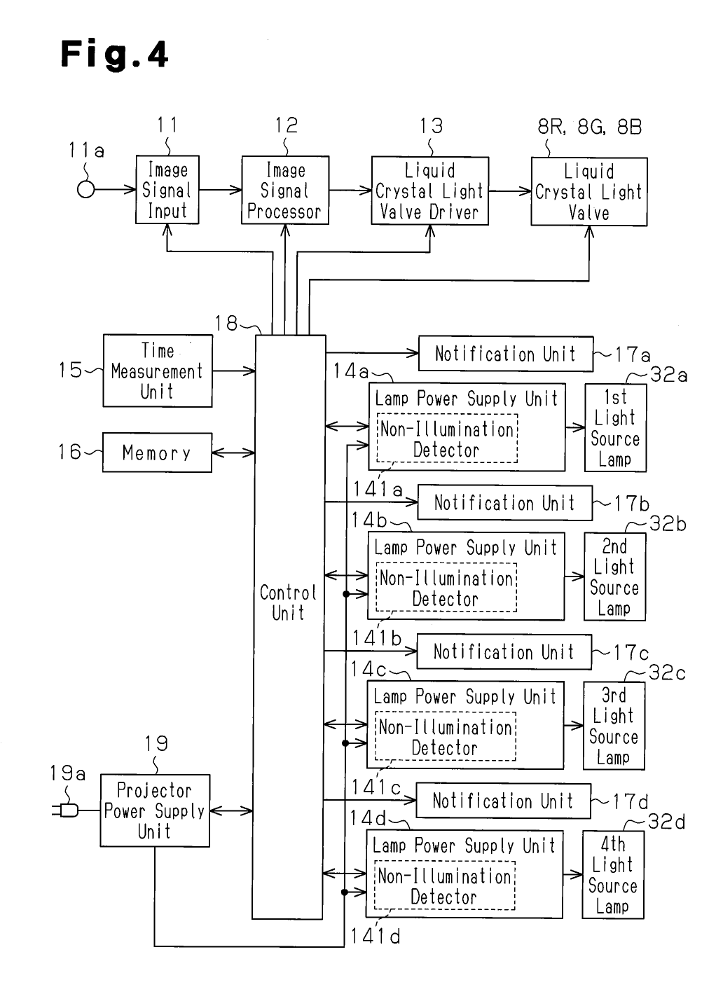

An electric circuit configuration of the video projector will now be discussed with reference to FIG. 4.

The video projector includes an image signal input 11, an image signal processor 12, a liquid crystal light valve driver 13, the liquid crystal light valves 8R, 8G, and 8B, the first to fourth light source lamps 32a to 32d, lamp power supply units 14a to 14d, a time measurement unit 15, a memory 16, notification units 17a to 17d, a control unit 18, and a projector power supply unit 19.

The image signal input 11 receives image signals via an input terminal 11a from various image reproduction devices. The image signal input 11 is applicable to various image signals from various image reproduction devices and includes input interfaces, such as an analog I/F, a digital I/F, and a video I/F. An image signal provided to the image signal input 11 undergoes processing, such as A/D conversion and decoding, and is converted into a digital signal, which is sent to the image signal processor 12.

The image signal processor 12 performs typical image processing on the received image signal, such as scaling, gamma correction, and luminance correction.

The liquid crystal light valve driver 13 converts the image signal received from the image signal processor 12 into a drive signal that drives the liquid crystal light valves 8R, 8G, and 8B for red, green, and blue light. The liquid crystal light valve driver 13 simultaneously generates drive pulses that drive the liquid crystal light valves 8R, 8G, and 8B.

Each of the liquid crystal light valves 8R, 8G, and 8B may include a liquid crystal panel. The liquid crystal panel includes liquid crystal that is driven at a rotational angle, which is in accordance with the input image signal, to transmit light from a separation optical system (not shown). The light transmitted through the liquid crystal light valves 8R, 8G, and 8B passes through the dichroic prism 9 and the projection lens 10 and forms an image on a remote display surface such as a screen.

The time measurement unit 15, or a timer, measures an accumulated illumination time of each light source lamp 32 and transmits the measurement result to the control unit 18. For each light source lamp 32, the time measurement unit 15 adds the illumination times to measure the accumulated illumination time.

The memory 16 stores a predetermined replacement determination time for the light source lamps 32. Further, the memory 16 updates the accumulated illumination time of each light source lamp 32 provided from the control unit 18. The memory 16 is, for example, a non-volatile memory.

The projector power supply unit 19 is connectable via a plug 19a to an external power supply. The projector power supply unit 19 includes an AC/DC converter and transforms, rectifies, and smoothes the AC power supplied from the external power supply to generates stable DC voltage.

The lamp power supply units 14a to 14d are respectively provided for the light source lamps 32a to 32d. The lamp power supply units 14a to 14d convert the AC voltage from the projector power supply unit 19 to a waveform voltage that is suitable for driving the corresponding light source lamps 32a to 32d. In accordance with a control signal from the control unit 18, the lamp power supply units 14a to 14d output a waveform voltage, which is suitable for activating the light source lamps 32a to 32d or suitable for the state of the light source lamps 32a to 32d during normal operation. The lamp power supply units 14a to 14d respectively include non-illumination detectors 141a to 141d, which detect when the corresponding light source lamps 32a to 32d are in a non-illuminated state. The non-illumination detectors 141a to 141d provide the control unit 18 with a non-illumination detection signal when the corresponding light source lamps 32a to 32d are not illuminated for one reason or another.

The control unit 18 is connected in a communicable manner to each part of the video projector. To illuminate the light source lamps 32, the control unit 18 provides the lamp power supply units 14a to 14d with control signals for the light source lamps 32a to 32d. The control unit 18 provides the memory 16 with the accumulated illumination time measured by the time measurement unit 15 to update the accumulated illumination time for each of the light source lamps 32a to 32d. The control unit 18 compares the updated illumination time of each of the light source lamps 32a to 32d with the replacement determination time stored in the memory 16. When determining that the accumulated illumination time of a light source lamp 32 is greater than the replacement determination time, the control unit 18 provides the corresponding one of the notification units 17a to 17d with a control signal indicating that the light source lamp 32 has reached its lifetime. When a non-illumination detection signal is received from one or more of the non-illumination detectors 141a to 141d of the lamp power supply units 14a to 14d, the control unit 18 provides the corresponding one of the notification units 17a to 17d with a control signal indicating that the corresponding one of the light source lamps 32 is not illuminated.

The notification units 17a to 17d may respectively include notification lamps (not shown) and light transmissive windows 171a to 171d (refer to FIG. 2) through which light from the notification lamps is transmitted. In accordance with a control signal from the control unit 18, the notification lamps are illuminated, for example, when the corresponding light source lamps 32a to 32d reach their lifetimes or when the corresponding light source lamps 32a to 32d cannot be illuminated. As shown in FIGS. 1 and 2, the notification units 17a to 17d are arranged near the corresponding lamp covers 2a to 2d. The notification lamps may be LEDs. In the illustrated example, the light transmissive windows 171a to 171d have simple circular shapes. The light transmissive windows 171a to 171d are arranged near outer sides of the corresponding lamp covers 2a to 2d so that the corresponding lamp covers 2a to 2d can be recognized at a glance. Among the four sides of each of the lamp covers 2a to 2d, the outer side refers to the side that is separated from and does not face toward a side of the other lamp covers. The lamp covers 2a to 2d are formed at positions corresponding to the light source lamps 32a to 32d on the outer surface of the shell case 1. In the illustrated example, the light source lamps 32a to 32d are arranged at corners of a square as shown in FIGS. 2 and 3. It is preferable that the light transmissive windows 171a to 171d of the notification units 17a to 17d be arranged at symmetrical positions.

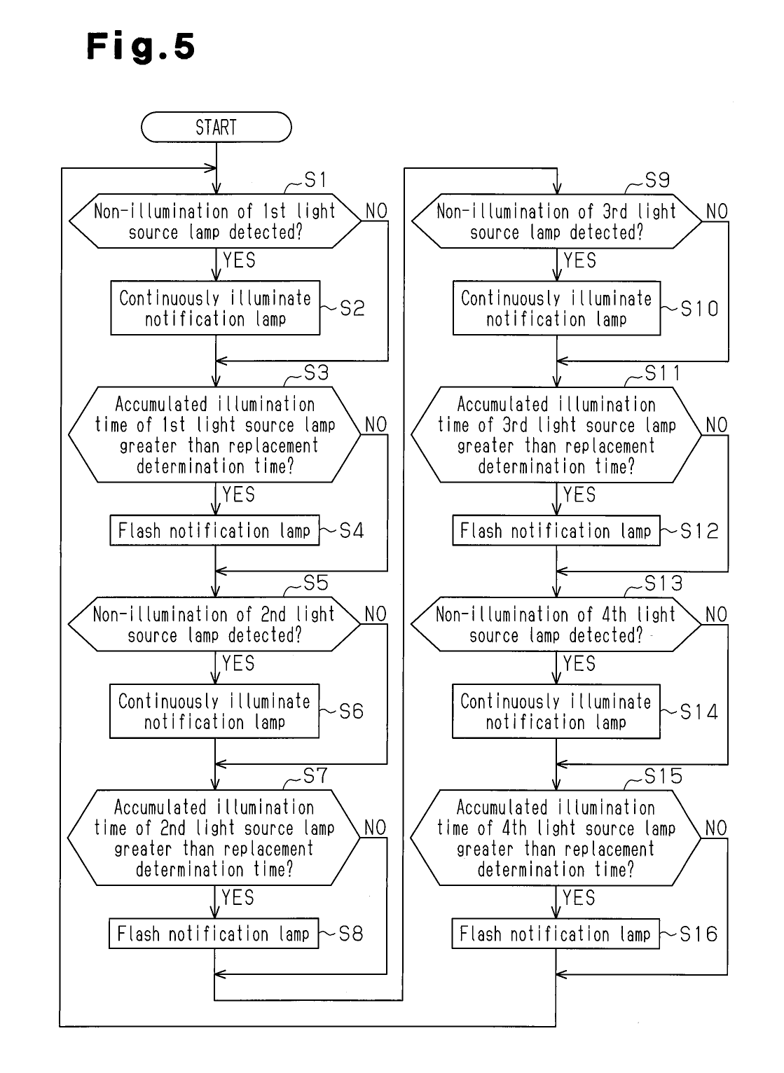

The illumination control of the notification lamps in the notification units 17a to 17d will now be described in detail based on the flowchart of FIG. 5.

The control unit 18 monitors the illumination state of the first light source lamp 32a in accordance with a signal from the non-illumination detector 141a of the lamp power supply unit 14a (step S1). When non-illumination of the first light source lamp 32a is detected (S1: YES), the control unit 18 continuously illuminates the notification lamp of the notification unit 17a for the first light source lamp 32a (step S2). When non-illumination of the first light source lamp 32a is not detected (S1: NO), the control unit 18 proceeds to step S3.

In step S3, the control unit 18 monitors the accumulated illumination time of the first light source lamp 32a measured by the time measurement unit 15. When the accumulated illumination time is greater than the replacement determination time (S3: YES), the control unit 18 flashes the notification lamp of the notification unit 17a for the first light source lamp 32a (step S4). When the accumulated illumination time of the first light source lamp 32a is not greater than the replacement determination time of the first light source lamp 32a (S3: NO), the control unit 18 ends the monitor control process of the first light source lamp 32a and proceeds to step S5.

In step S5, the control unit 18 monitors the illumination state of the second light source lamp 32b in accordance with a signal from the non-illumination detector 141b of the lamp power supply unit 14b. When non-illumination of the second light source lamp 32b is detected, the control unit 18 continuously illuminates the notification lamp of the notification unit 17b for the second light source lamp 32b (step S6). When non-illumination of the second light source lamp 32b is not detected, the control unit 18 proceeds to step S7 and monitors the accumulated illumination time of the second light source lamp 32b.

In step S7, the control unit 18 monitors the accumulated illumination time of the second light source lamp 32b measured by the time measurement unit 15. When the accumulated illumination time is greater than the replacement determination time of the second light source lamp 32b, the control unit 18 flashes the notification lamp of the notification unit 17b for the second light source lamp 32b (step S8). When the accumulated illumination time of the second light source lamp 32b is not greater than the replacement determination time of the second light source lamp 32b, the control unit 18 ends the monitor control process of the second light source lamp 32b.

When the monitor control process of the second light source lamp 32b ends, the control unit 18 monitors non-illumination and the accumulated illumination time in the same manner for the third and fourth light source lamps 32c and 32d (steps S9 to S16). The control unit 18 repeats steps S1 to S16.

The present embodiment has the advantages described below.

(1) The control unit 18 determines whether or not the accumulated illumination time of each light source lamp 32 is greater than the replacement determination time. When the accumulated illumination time of one light source lamp 32 is greater than the replacement determination time, the control unit 18 illuminates the notification lamp of the corresponding notification unit. This notifies the user of the location of the one of the lamp covers 2a to 2d corresponding to that light source lamp 32. Accordingly, the illumination of the notification lamp notifies the user of the necessity to replace the light source lamp 32. In addition, the user is notified of the location of the lamp cover 2a to 2d corresponding to the light source lamp 32 that needs to be replaced. This facilitates the replacement of the light source lamp 32.

(2) A lamp cover automatic opening device such as that used in the prior art is unnecessary. Thus, interference does not occur between the lamp covers 2a to 2d and surrounding objects. Further, there is no need to worry about the automatic opening device failing to function properly or damage being inflicted on surrounding objects.

(3) In comparison with the lamp cover automatic opening device of the prior art, the notification units 17a to 17d occupy less space. This allows the size of the video projector to be comparatively reduced.

(4) The notification units 17a to 17d are arranged near the lamp covers 2a to 2d. Accordingly, the light source lamp 32 that is to be replaced and the location of the corresponding lamp cover 2a to 2d can be simultaneously signified by illuminating the notification lamp, which has a simple structure.

(5) Each of the notification units 17a to 17d illuminates the corresponding notification lamp in different modes when the corresponding light source lamp 32 can be illuminated but the accumulated illumination time of the light source lamp 32 is greater than the replacement determination time and when the corresponding light source lamp 32 is thus non-illuminated, or cannot be illuminated. Accordingly, in each of the notification units 17a to 17d, the same notification lamp can be used to notify the user of two different states of the corresponding light source lamp 32. In the illustrated example, a notification lamp is flashed to notify the user of a state in which the corresponding light source lamp 32 can be illuminated but the accumulated illumination time of the light source lamp 32 is greater than the replacement determination time. Further, a notification lamp is continuously illuminated to notify the user of a state in which the corresponding light source lamp 32 is non-illuminated due to its life or for other reasons.

It should be apparent to those skilled in the art that the present invention may be embodied in many other specific forms without departing from the spirit or scope of the invention. Particularly, it should be understood that the present invention may be embodied in the following forms.

There may be only one light source lamp 32. In this case, there is only one lamp cover and one notification unit that correspond to the single light source lamp. Such a structure would also notify the user of the necessity to replace the light source lamp 32 or the location of the lamp cover corresponding to the light source lamp 32 that should be replaced. Further, a lamp cover automatic opening device such as that used in the prior art is unnecessary. Since the lamp cover does not open automatically, interference does not occur between the lamp cover and surrounding objects and damages are not inflicted on the surrounding objects. Additionally, since a lamp cover automatic opening device is unnecessary, the notification unit occupies less space.

The number of light source lamps 32 is not limited to one or four and may be any number of light source lamps.

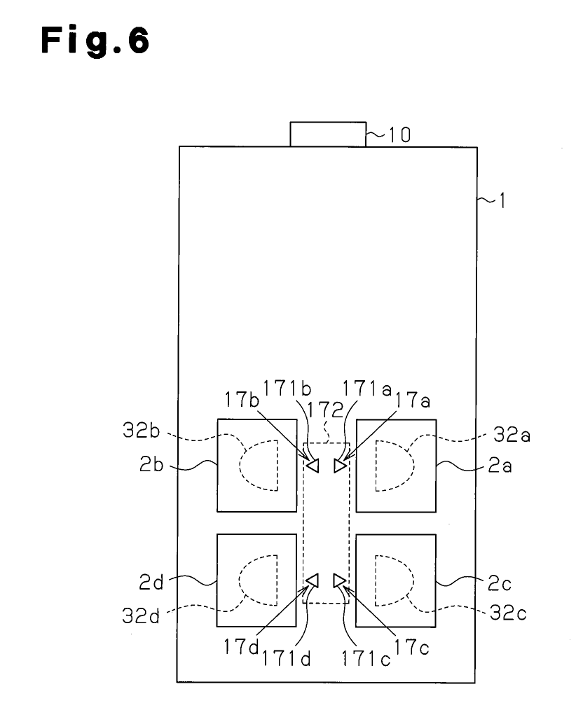

The light transmissive windows 171a to 171d of the notification units 17a to 17d may have any shape as long as it is suitable for indicating the corresponding one of the lamp covers 2a to 2d. For example, as shown in FIG. 6, the light transmissive windows 171a to 171d may be triangular and include peaks indicating the corresponding lamp covers 2a to 2d. Such a structure allows for easy arrangement of a plurality of notification lamps on a single substrate 172 and simplifies the structures of the notification units 17a to 17d, which includes a plurality of notification lamps. Further, the notification units 17a to 17d may be arranged in the space between the lamp covers 2a to 2d. A plurality of light transmissive windows may also be arranged near one another so that the user can recognize light source lamps that need to be replaced without making mistakes.

The present examples and embodiments are to be considered as illustrative and not restrictive, and the invention is not to be limited to the details given herein, but may be modified within the scope and equivalence of the appended claims.

1. A video projector comprising:
a replaceable light source lamp;
a case that accommodates the light source lamp, wherein the case includes a service port arranged in correspondence with the light source lamp;
a lamp cover arranged on the case to close the service port, wherein the lamp cover opens to allow for the light source lamp to be replaced through the service port;
a time measurement unit that measures an accumulated illumination time of the light source lamp;
a control unit that determines whether or not the accumulated illumination time of the light source lamp is greater than a replacement determination time; and
a notification unit that includes a notification lamp and illuminates the notification lamp, when it is determined that the accumulated illumination time of the light source lamp is greater than the replacement determination time, to indicate where the lamp cover corresponding to the light source lamp is located.

2. The video projector according to claim 1, wherein the notification unit illuminates the notification lamp in different modes a) when the accumulated illumination time of the light source lamp is greater than the replacement determination time but can be illuminated and b) when the light source lamp is in a non-illuminated state, respectively.

3. A video projector comprising:
a plurality of replaceable light source lamps;
a case that accommodates the light source lamps, wherein the case includes a plurality of service ports used to replace the light source lamps, respectively;
a plurality of lamp covers arranged on the case to close the service ports, wherein the lamp covers respectively correspond to the light source lamps, and each of the lamp covers opens to allow for the corresponding light source lamp to be replaced through the corresponding service port;
a time measurement unit that measures an accumulated illumination time of each of the light source lamps;
a control unit that determines whether or not the measured accumulated illumination time is greater than a replacement determination time; and
a plurality of notification units arranged on the case, wherein the notification units respectively correspond to the light source lamps, and each of the notification units is illuminated, when it is determined that the accumulated illumination time of the corresponding light source lamp is greater than the replacement determination time, to indicate where the corresponding lamp cover is located.

4. The video projector according to claim 3, wherein the notification units are arranged near the corresponding lamp covers.

5. The video projector according to claim 4, wherein each of the notification units includes a notification lamp and a light transmissive window, which is formed in the case and transmits light from the notification lamp, and the light transmissive window is shaped to indicate where the corresponding lamp cover is located.

6. The video projector according to claim 5, wherein the notification units are arranged in a space defined between the lamp covers.

7. The video projector according to claim 3, wherein each of the notification units is illuminated in different modes a) when the accumulated illumination time of the corresponding light source lamp is greater than the replacement determination time but can be illuminated and b) when the light source lamp is in a non-illuminated state, respectively.

8. A video projector comprising:
a plurality of light source lamps;
a case that accommodates the light source lamps, wherein the case includes a plurality of lamp covers respectively corresponding to the light source lamps, and each of the lamp covers opens to allow for the corresponding light source lamp to be accessed;
a time measurement unit that measures an accumulated illumination time of each of the light source lamps;
a control unit that determines whether or not the measured accumulated illumination time is greater than a replacement determination time; and
a plurality of notification units arranged on the case, wherein the notification units respectively correspond to the light sources, and each of the notification units is illuminated, when it is determined that the accumulated illumination time of the corresponding light source lamp is greater than the replacement determination time, to indicate where the corresponding lamp cover is located.

9. The video projector according to claim 8, wherein the notification units are arranged near the corresponding lamp covers.
